(19) United States
(12) Patent Application Publication
(10) Pub. No.: US 2007/0140912 A1
(43) Pub. Date: Jun. 21, 2007

(54) Fiber optic interrogated microfluidic device

(76) Inventors: Michael J. Minot, Andover, MA (US); Michael A. Detarando, Sturbridge, MA (US); Jason Kass, Auburn, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/587,141

(22) PCT Filed: Jan. 24, 2005
(86) PCT No.: PCT/US05/02087

§ 371 Date: Jul. 21, 2006

Related U.S. Application Data
(60) Provisional application No. 60/538,450, filed on Jan. 22, 2004.

(51) Int. Cl. B01L 3/02

(52) U.S. Cl. 422/100

(57) ABSTRACT

The present invention provides a microfluidic device that can be used for fiber optic interrogation of multiple samples. The device comprises a substrate integrally comprising a plurality of optic fibers. A layer formed on a surface of the substrate defines at least one topological feature that communicates with at least one optic fiber for interrogation of a sample. The device preferably comprises a plurality of topological features that may include a patterned array of wells, channels or any combinations thereof. The plurality of optic fibers of a device of the invention are capable of interrogating thousands of samples simultaneously. These samples may include, without limitation, molecular, cellular, proteomic, genomic or gaseous materials or assays. The present invention also discloses a method for fabricating a microfluidic device. The invention also comprises a method for interrogating multiple samples in parallel via the microfluidic devices provided herein.

### CROSS REFERENCE TO RELATED APPLICATIONS

This application claims the priority of U.S. Provisional Application No. 60/538,450 filed Jan. 22, 2004 and entitled, MICROARRAY PLATE WITH LARGE DIAMETER, HIGH RESOLUTION WELLS, MICROFLUIDIC FIBER OPTIC INTERROGATED MICROWELL BIOCHIPS, which is hereby incorporated by reference herein.

### BACKGROUND OF THE INVENTION

The field of microfluidics concerns the fabrication and use of devices that have dimensions on the order of micrometers (μm) to millimeters (mm). The microsize and microfeatures of these devices offers significant potential for research and applications within such disciplines as medicine, biochemistry, chemistry and biology. An individual microfluidic device can be used to simultaneously investigate up to thousands of samples from a diverse group of biological and chemical materials or assays. Other applications for these devices include molecular, cellular, proteomic, genomic, gaseous analyses and diagnostics in addition to the interrogation of biological, chemical or physical events.

One class or group of microfluidic devices that has garnered considerable interest consists of microarray plates. Such plates are generally composed of materials that can include silicon, glass or plastic. A microarray plate may support or contain samples for investigation that are deposited onto the plate surface or into boundaries or other physical features etched and distributed across a plate surface. For example, a typical microarray plate can include thousands of discrete sample wells. These wells are commonly 1 μm to 250 μm in diameter. A convenient means for investigating samples deposited into such wells does not exist. One approach has been to use diagnostic tools to interrogate a sample well by inserting the tool into the well, although this approach is impractical for sensitive materials.

Another approach employed to interrogate sample wells has been to use chemically etched wells that have an optic fiber bottom. The fabrication of these etched wells often involves a plate comprised of optic fibers that have a core glass center region surrounded by clad glass that has been fused together. A chemical etchant such as a mineral acid selectively dissolves the soluble core glass of the fibers without perturbing the more resistant clad glass. The core glass dissolves to yield wells that are physically defined by the intact clad glass such that well diameters correspond to a particular optic fiber diameter.

A second group of microfluidic devices that has been used extensively in biological and chemical research consists of microtiter plates. Microtiter plates are typically plastic devices featuring an arrangement of discrete wells that are significantly larger than the wells of a standard microarray plate. Screening conventions have standardized the arrangement and dimensions of wells across a microtiter plate. Such standards require the number of wells per individual plate to be 96, 192, 384 or 1536. The wells of a microtiter plate tend to vary from about 1.5 mm to 7.0 mm. Several diagnostic instruments have also been developed to be able to observe biological, chemical or physical events that occur within the wells. Jianbing et al., “High-density fiber optic array technology and its applications in genomic studies,” Chin. Sci. Bull., Vol. 48, No. 18, pp. 1903-05 (2003). These instruments generally are not integral with the microtiter plate, which tends to impede both optical resolution and sensitivity.

The development of fiber optic interrogated microfluidic devices requires a convenient fabrication method. The method should not restrict microfeatures or sizes to that of individual optic fibers. A standardized method is needed for fabricating devices that can perform as either a microarray or microtiter plate. The method should not require a mask or equivalent tool that is exposed to chemical etchants. The method should further minimize the production of residual and glass byproducts, which can pose significant environmental issues.

A microfluidic device fabricated by a method without such limitations must also be convenient for investigating thousands of samples simultaneously. The ability to interrogate thousands of samples in parallel would present a significant diagnostic or analytical tool. A need also exists for readily customizing a microfluidic device for a specific area of research. The device should not be restricted by conventional standards of fabrication. A microfluidic device is needed that could integrally interrogate multiple sample wells of varying size. The sample interrogations should be performed by a means integral with the device so as to enhance optical resolution and sensitivity. The device should also not require a glass or plastic cover slip or any other translucent platform through which a sample may be viewed as such would necessarily distort optical interrogation.

### SUMMARY OF THE INVENTION

The present invention provides a microfluidic device that can be used for fiber optic interrogation of multiple samples. The device comprises a substrate that integrally comprises a plurality of optic fibers. A layer formed on a surface of the substrate also defines at least one topological feature, which communicates with at least one optic fiber for interrogation of a sample. The device of the invention preferably comprises a plurality of topological features that may include a patterned array of wells, channels or a combination thereof. The plurality of optic fibers associated with the microfluidic device are capable of simultaneously interrogating up to thousands of samples. The samples may include, without limitation, molecular, cellular, proteomic, genomic or gaseous materials or assays. Any biological, chemical or physical event associated with such materials or assays can be interrogated by a device of the invention. The microfluidic device can be fabricated to be a fiber optic interrogated microarray or microtiter plate based on the particular application for which it is intended to be used.

The layer deposited on the surface of the substrate can be comprised of any material that is practical for adhesion to the substrate without interfering with fiber optic interrogation. In one embodiment, a layer is deposited onto the substrate by a suitable deposition technique including, for instance, spin-on deposition, screen printing, tape casting, cold pressing, ink jet printing, hot embossing or chemical vapor deposition. The layer is preferably a photoresist material such as a polymeric resin that is spun-on a substrate. One or more portions of the layer may be cured or hardened such as by exposure to a light source through an opening in a photomask. The exposed portions form hardened topological features along the layer. Portions of the layer that are unexposed remain unhardened and these portions may then be mechanically or chemically removed such as by a solvent.

The curing or hardening of the layer could be accomplished by processes that include, for example, photopolymerization, polymerization, thermal curing or photocuring. The topological features of the layer can also comprise a patterned array of wells, channels or a combination thereof. As the layer is cured, it begins to adhere to the surface of the substrate. The layer adheres best to the substrate when the substrate surface has been evenly polished. One embodiment of the invention features a substrate that integrally comprises optic fibers having a core glass region surrounded by clad glass, although any substrate material that does not interfere with optical interrogation might also be used. A microfluidic device of the invention preferably comprises a substrate that integrally comprises optic fibers as such a substrate does not have an intrinsic glass tolerance that could interfere with or distort optical interrogation.

The topological features of a layer can vary in size from micrometers (μm) to millimeters (mm) and may also vary in volume. The thickness of a hardened layer adhered to the substrate also tends to vary depending on the intended use of the microfluidic device. In one embodiment of the invention, the device can have a layer thickness of about 1 μm to 200 μm when used as a microarray plate. For another embodiment of the invention, a device could have a layer thickness up to approximately 1000 mm, which can be an individual layer or several layers deposited onto one another on the surface of the substrate. A hardened layer according to the invention becomes integral with the substrate of a particular device.

A well formed in a given layer communicates with at least one optic fiber of the substrate. In one embodiment, a particular well might communicate with a plurality of optic fibers that could number up to and include thousands. An embodiment of the invention having a plurality of optic fibers that communicate with an individual well is generally used as a microarray or microtiter plate. A device may also include numerous wells communicating with different optic fibers that can simultaneously interrogate multiple samples. The optic fibers of the invention can be coupled to standard detection equipment including, for example, at least one charged coupled device (CCD). Conventional detection equipment often comprises hardware and software appropriate for optical interrogation. The microfluidic device can also include several channels formed by the hardened layer that separates portions of the device for interrogation of different samples such as a fluid. The device may also comprise a label formed in or otherwise integral with the layer deposited onto the substrate for device identification.

Another embodiment of the invention comprises a second layer formed on the original layer of the microfluidic device. The second layer is preferably a photoresist material such as a polymeric resin. The second layer is deposited on the substrate by any suitable deposition technique such as those previously described. A photomask may also be used to form topological features along the second layer as it is hardened by processes that include, for example, photopolymerization, polymerization, thermal curing or photocuring. The second layer can provide a microfluidic device that operates as a network. The network can be used for fiber optic interrogation of a fluid sample such as, for example, a molecular, a cellular, a proteomic or a genomic material or assay. The network can also be used to interrogate any biological, chemical or physical event associated with such materials or assays.

The present invention also provides a method for fabricating a microfluidic device. The method includes providing a substrate integrally comprising a plurality of optic fibers. A surface of the substrate is ground and polished to provide for even and uniform distribution of a layer. Such a layer is deposited onto the substrate surface by such deposition techniques as spin-on deposition, screen printing, tape casting, cold pressing, ink jet printing, hot embossing, chemical vapor deposition and so forth. One or more portions of the layer are then cured or hardened to form topological features that can communicate with at least one optic fiber for interrogation of a sample. The microfluidic device preferably comprises a plurality of topological features that comprise, without limitation, a patterned array of wells, channels or a combination thereof. The present invention further provides a method for interrogating multiple samples in parallel via a microfluidic device fabricated according to a method of the invention.

### DESCRIPTION OF THE DRAWINGS

Other features and advantages of the present invention will be apparent from the detailed description of the invention that follows, taken in conjunction with the accompanying drawings of which:

FIG. 1 is a partial representation of a substrate of the invention integrally comprising a plurality of optic fibers;

FIG. 2 shows four schemes for depositing a second layer onto a deposited layer of a substrate of the invention;

FIG. 3 is a magnified image of six microfluidic devices according to the invention in which each device has a different microwell patterned array;

FIG. 4 is a magnified image of one microwell from the third microwell patterned layer in FIG. 3;

FIG. 5 shows a scheme for fabrication of a microfluidic device of the invention;

FIG. 6 is a magnified image of a 4 by 4 microwell patterned array;

FIG. 7 is a partial representation of a device of the invention comprising a layer having channeled features; and

FIG. 8 is a partial representation of the microfluidic device in FIG. 7 comprising a second layer having channeled features disposed onto the first layer.

### DEFINITIONS

Unless otherwise stated, the following definitions provide meaning and examples to terms used herein. Such definitions are also intended to encompass any meaning that would be contemplated by a person of ordinary skill within the art.

The term “topological feature” generally refers to a type of structure or element that is along, near or integral with the surface of any material. Examples of such structures or elements include, without limitation, wells, channels, loading ports, flow control channels, nutrient channels, mixing and reactions zones, recovery wells or any combination thereof.

The term “array” generally refers to an arrangement of a plurality of features such as a plurality of wells, channels, loading ports, flow control channels, nutrient channels, mixing and reactions zones, recovery wells or any combination thereof.

The term “interrogation” broadly refers to any observation, analysis or examination of a sample. An observation, analysis or examination may be facilitated by using at least one optic fiber or a related element such as an optical fiber probe. An observation, analysis or examination could further be aided by conventional detection equipment such as, for example, a charged coupled device (CCD) or an automated auto-focusing microscope.

The term “microarray plate” generally refers to a plate comprising an array of features. The plate can, for example, comprise a plurality of uniformly distributed wells with each well being from about 1 micrometer (μm) to 250 μm in diameter and capable of physically containing or holding a sample such as a material or an assay.

The term “tolerance” or “glass tolerance” generally relates to a limited or reduced optical resolution, sensitivity and so forth that results when an observation, analysis, interrogation or examination is performed or carried out through the thickness of a substantially translucent material, such as, for instance, glass, through which an observation, analysis, interrogation or examination is carried out or performed. For example, a glass cover slide from beneath which an optical interrogation is performed has an inherent glass tolerance that increases with the thickness of the glass.

The term “microtiter plate” generally refers to a plate comprising an array of features. The plate can, for example, comprise any number of wells and the wells are often arranged into a pattern. The plate can comprise, without limitation, 96, 192, 384 or 1536 uniformly distributed wells with each well being up to about 10 millimeters (mm) in diameter and capable of physically containing a sample such as a material or an assay.

The term “event” generally refers to a type of biological, chemical or physical occurrence or activity such as observed in, without limitation, molecular, cellular, proteomic, genomic, gaseous materials or assays and any combinations thereof. Such biological, chemical or physical occurrences or activities can include, but are not limited to, reactions, chemiluminescence, mitosis, fluorescence, degradation or growth.

The term “sample” generally refers, but is not limited to, molecular, cellular, proteomic, genomic, gaseous materials or assays including any combinations thereof.

The term “feature resolution” refers to the repeatability or reproducibility of sizes and microsizes relating to specific features or the difference among particular features that can include, without limitation, wells, channels, loading ports, flow control channels, nutrient channels, mixing and reactions zones, recovery wells or any combination thereof.

### DETAILED DESCRIPTION OF THE INVENTION

The present invention provides a microfluidic device that can be used for fiber optic interrogation of multiple samples. The device comprises a substrate that integrally comprises a plurality of optic fibers and a layer formed on a surface of the substrate. The formed layer defines at least one topological feature that may communicate with at least one optic fiber for interrogation of a sample. The device of the invention preferably comprises a plurality of topological features that may include a patterned array of wells, channels or a combination thereof. The plurality of optic fibers enable the microfluidic device to be used for simultaneously interrogating multiple samples. The samples may include, but are not limited to, molecular, cellular, proteomic, genomic or gaseous materials or assays. A biological, chemical or physical event associated with such materials or assays can also be interrogated by a microfluidic device of the invention. The device can further be fabricated to be a fiber optic interrogated microarray or microtiter plate depending on the application for which it is intended to be used.

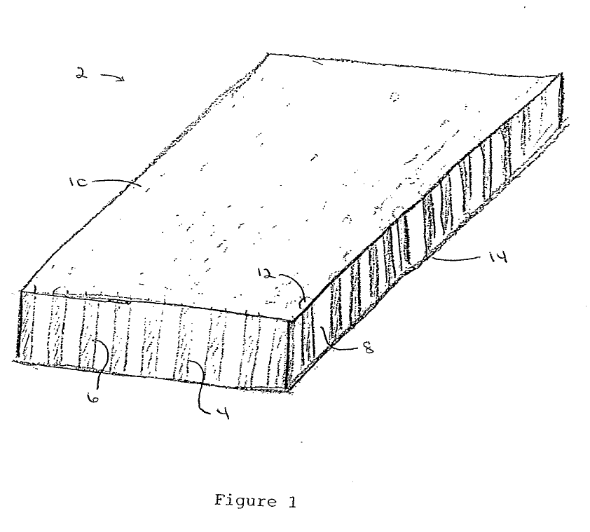

A microfluidic device according to the invention can be fabricated by depositing a layer onto a substrate or plate. The substrate may integrally comprise a plurality of optic fibers. FIG. 1 is a partial representation of a substrate 2 integrally comprising optic fibers 4 that comprise a central core glass region 6 surrounded by clad glass 8. The plurality of optic fibers are shown to be bundled and fused together by the clad glass. The fibers may be bundled and fused together by any suitable technique such as those used in standard manufacturing practices. The plurality of optic fibers may also be coupled to conventional detection equipment including at least one charged coupled device (CCD).

Exemplary optic fibers and detection equipment according to the invention are described by Schempp, “Fiber optic imagining: An introduction,” SC32 Short Course Notes, SPIE (1994). Among other things, the reference also describes, without limitation, arrangements, configurations, assemblies, materials or any other variations for optic fibers and detection equipment of the invention. A microfluidic device of the invention can also be used with other conventional detection equipment such as, for instance, an auto-focusing microscope. Auto-focusing microscopes are commonly automated to be used in high-throughput screening applications. These microscopes could be used, for example, to rapidly interrogate or observe thousands of biological, chemical or physical events.

The surface 10 of the substrate in FIG. 1 is further shown to be evenly ground and polished for the deposition of a layer. In one embodiment of the invention, a microfluidic device may comprise a substrate that integrally comprises optic fibers as such a substrate does not have an intrinsic glass tolerance that could interfere with optical interrogation. The substrate 2 of FIG. 1 does not have a glass tolerance as optic fibers 4 integrally comprise the substrate and its surface 10 such that interrogation via the fibers need not be performed through a material such as a glass or plastic cover slip or any other type of translucent platform. An exemplary microfluidic device has a layer deposited onto the optic fibers integrally comprising the substrate.

A microfluidic device of the invention is particularly well suited to be used with at least one auto-focusing microscope as an exemplary substrate of such a device does not have an intrinsic glass tolerance. Absent an intrinsic glass tolerance, any sort of interrogation need not be performed through a glass or plastic cover slip or any other translucent platform. For a conventional auto-focusing microscope, such cover slides or other translucent platforms can act as windows through which an interrogation or observation is made. An observation made through a window poses significant focusing problems for such microscopes. An exemplary microfluidic device of the invention may overcome any focusing related issues by not requiring a glass or plastic cover slip or any other translucent platform through which an interrogation is made from above or below. Without such a glass or plastic cover slip or translucent platform, the quality, resolution and rate of sample interrogation, among other things, tends to improve. Cook et al., “Fiberoptics for displays,” Inf. Disp., pp. 14-16 (1991).

FIG. 1 also shows that the optic fibers 4 comprise a core glass region 6 surrounded by clad glass 8. The optic fibers 4 are oriented to receive light through an upper end 12 and emit light through a lower end 14 for detection using conventional detection equipment. An example of such detection equipment may include hardware and software that is suitable for optical interrogation. An embodiment of the invention may comprise standard detection equipment including at least one CCD. The CCD can be coupled to at least one optic fiber to receive data or a signal from the fiber and electronically convert such to an image. The image that is obtained represents an interrogation performed by at least one optic fiber from the plurality that comprises the substrate. An example of the components, materials and assemblies of standard detection equipment and at least one CCD coupled to an optic fiber is described by Schempp et al., “Large area CCD-fiber optic imager assembly,” Proc. SPIE, Vol. 1901, pp. 142-45 (1993).

The substrate or plate of a microfluidic device of the invention could further be comprised of any suitable material. The materials might include those that do not interfere with optical interrogation and permit good adhesion of the deposited layer. The substrate may also integrally comprise optic fibers surrounded by a biological, biopolymer synthetic, metallic, polymer or nonmetal material. For example, the substrate could integrally comprise optic fibers set in a matrix of plastic. As discussed above, the optic fibers of the invention can have a central core glass region surrounded by fused clad glass. In a preferred embodiment, the core glass may comprise a central region of each optic fiber comprising the substrate.

A microfluidic device of the invention can also comprise optic fibers that are partially or entirely plastic as well as those that have a hollow core region. In an embodiment according to the invention, the substrate could integrally comprise many types of interrogation or diagnostic elements. These elements can further include fiber optic probes or any device that is microsized and capable of interrogating or analyzing molecular, cellular, proteomic, genomic or gaseous materials or assays and any biological, chemical or physical event associated with such materials or assays that occurs along or near the surface of the substrate. Such diagnostic elements may refer to optic fibers that are substantially glass or plastic.

Conventional manufacturing practices have been established for fabricating a substrate such as shown within FIG. 1. A typical manufacturing process can begin with a core glass rod sized to fit within a clad glass tube. The core glass rod and clad glass tube are then loaded into a furnace in which the rod and the tube are fused together and drawn into a length of cane having a standard diameter of approximately 2.5 millimeters (mm). Several lengths of cane are assembled into billets that can be redrawn to yield a multi-structure. The multi-structure may then be assembled into a second billet that is also drawn to form a multiple multi-structure. These billet multi-structures are then cut into a desired length and stacked into a pressing fixture forming an assembled mold. The assembled mold is then placed in a pressing furnace.

The pressing furnace heats and softens the cane lengths as a load is applied to the mold. The resulting block is then annealed and fabricated into a substrate integrally comprising core glass optic fibers surrounded by fused clad glass. The substrate can be cut into rectangular plates having a nominal thickness intended for a specific application or use. The substrate mi ght then be ground and polished to particular dimensions using one or more glass finishing slurries and pad materials. Other variations and modifications relating to the fabrication of a substrate according to the invention might be apparent to a person of ordinary skill in the art.

The fabrication of a substrate according to the invention is also generally described by Krans, “An introduction to fiber optic imaging,” 1st edition, Schott Fiber Optics, Incorporated. The reference further describes detection equipment such as a CCD that could be used with the optic fibers of the invention for interrogation. The reference also describes, among other things, arrangements, configurations, assemblies, materials or any other variations for optic fibers of the invention that may be used to integrally comprise an exemplary substrate. Substrate fabrication according to the invention is further disclosed and described within U.S. Pat. Nos. 4,778,501 and 4,925,473, which are incorporated by reference herein.

A substrate or plate of the invention can be fabricated by such described conventional manufacturing practices. A substrate fabricated by these standard practices is generally comprised of optic fibers arranged and aligned with one another such that the axes of the optic fibers are perpendicular to the light input and output surfaces of the substrate. As mentioned, such a substrate does not have an intrinsic tolerance as light impinging on the input surface is directly transmitted to the output surface. This result tends to limit the extent of any optical distortion and can also improve interrogation resolution. A substrate according to the invention might also comprise optic fibers that are tapered for more efficient light collection. A microfluidic device of the invention further does not require that fiber optic interrogation occur through, for instance, a glass or plastic cover slide or any other translucent platform. These slides or platforms act as windows through which light is gathered and transmitted and can effect optical resolution and quality as well as increase the extent of optical distortion.

The selection of both clad and core glass for the optic fibers of a substrate is accomplished such that their chemical and physical properties can be matched. The ratio of core glass area to the total area of an optic fiber may vary depending on a particular application. A typical percentage of core glass area to total area is approximately 70 percent (%) to 90%. The optical properties of a given optic fiber similarly depend on a relative refractive index between the core and clad glass. In one type of embodiment, it may be preferable for the refractive index of the core glass to be larger than that of the clad glass such that incident light will be constrained to the core of the optic fiber and not leak into the clad glass.

The invention further contemplates use of an extra mural absorption (EMA) glass. EMA glass is a type of glass that is highly absorptive and can be integral with the clad glass of a substrate to absorb light that leaks from the core glass of an optic fiber. The absorption of light leaking from the core glass of an optic fiber tends to improve optical signaling and image quality. As described, optic fibers that integrally comprise a substrate of the invention can be substantially perpendicular to the surface of the substrate. The invention also contemplates other optic fiber configurations that could be used to enhance any sort of interrogation.

A substrate of the invention minimizes or prevents light loss and optical distortion that can occur during interrogation. A substrate integrally comprising optic fibers also has superior resolution and optical transmission in comparison to typical systems for interrogation that observe biological, chemical and physical events through, for example, a glass or plastic window. In one embodiment, the fibers provide an optical link between the interrogated substrate surface and standard detection equipment such as at least one CCD. This arrangement can overcome common interrogation problems or limitations such as encountered when standard detection equipment is used for direct observation or when interrogation occurs through an optical lens or translucent platform. The use of at least one CCD for direct observation, for example, generally requires that the interrogated surface be flat. Interrogation via optic fibers of the invention coupled to at least one CCD does not require a flat surface for interrogation.

The layer deposited on the substrate can be comprised of any material that is practical for adhesion to the substrate without interfering with fiber optic interrogation. Such materials could include, but are not limited to, polymer, biological, synthetic, metallic, biopolymer or nonmetal materials. The deposited layer is capable of defining at least one topological feature having feature resolutions and other related dimensional precisions that are satisfactory for a particular application. One embodiment of the invention features a layer having a plurality of topological features with microsized dimensions. For example, a microfluidic device may comprise a plurality of wells across the layer with each well having a depth and diameter on the microscale. The individual wells could also be several μm apart from one another when measured from a well center to that of another well. The distance from one well center to the center of a different well is known as a pitch.

In one embodiment, the layer is substantially a photoresist material. The photoresist may preferably be a polymeric resin. The photoresist material that comprises the layer could also be photopolymerized, polymerized, thermally cured or photocured after deposition onto the surface of a microfluidic device substrate. The layer may also be sensitive to ultraviolet (UV) or near UV light. UV or near UV light introduced to the layer may be from a source such as a mercury or hydrogen arc source or discharge lamp. The UV or near UV light can photocure or photopolymerize the layer after deposition onto the substrate surface. The invention also contemplates a photoresist layer that is a combination of polymeric resins.

An example of a polymeric resin that can be photocured is the photoresist SU-8. SU-8 and several related SU-8 polymeric resins including, for example, SU-8 2000, SU-8 2001, SU-8 2002, SU-8 2007, SU-8 2010, SU-8 2015, SU-8 2025, SU-8 2100 or SU-8 3000 are available from MicroChem Corporation of Newton, Mass. These polymeric resins could be deposited onto a substrate of the invention. SU-8 and related SU-8 resins are also preferable photoresists as the resins adhere well to the substrates of the invention and exhibit good wettability. These photoresist resins further tend to be very durable after the resin has been cured and sufficiently cross-linked.

Chemically SU-8 is a sufficiently epoxidized bisphenol-A and formaldehyde novolac copolymer structure that becomes a thick film negative photoresist when combined with an appropriate photoacid generator (PAG) such as a cationic PAG. Upon exposure to UV or near UV light for curing, strong acid and protons are generated that then initiate cationic polymerization of the epoxy monomers due to a photochemical reaction of the PAG. Li et al., “Rapid three-dimensional manufacturing of microfluidic structures using a scanning laser system,” Appl. Phys. Lett., Vol. 85, No. 12, pp. 2426-28 (2004). The reaction is generally complete and the resins are sufficiently cross-linked after a subsequent post-exposure bake or any other thermal heat treatment.

UV or near UV curing of any SU-8 and related SU-8 resin and post-exposure baking of the resin yields highly dense cross-linked polymer networks that are chemically, thermally and mechanically stable. An SU-8 photoresist layer deposited onto a substrate can become integral with the substrate. An SU-8 cured layer is also resistant to solvents, acids or bases and tends to exhibit good feature resolution. An SU-8 resin layer can be cured when exposed to UV or near UV light within a wavelength range from about 350 nanometers (nm) to 450 nm. The polymer structure of SU-8 prior to curing or post-exposure baking is generally not cross-linked and can be readily dissolved by such solvents that include, without limitation, cyclopentanone, gamma-butyrol-acetone (GBL), diacetone alcohol, methyl isobutyl ketone, ethyl lactate or propylene-glycol-methyl ether (PGME).

SU-8 and related SU-8 resins can be formulated in, for example, cyclopentanone, GBL, diacetone alcohol, methyl isobutyl ketone, ethyl lactate or PGME. A photoresist resin layer of the invention may be deposited in a variety of thicknesses. In one embodiment, a thickness of 200 μm may be obtained by an SU-8 or SU-8 related resin. Another embodiment according to the invention can have a layer thickness up to approximately 1000 mm, which could comprise an individual layer or several layers deposited onto each other on the substrate surface. One example of a 1000 mm SU-8 photoresist layer is described by Loechel, “Thick-layer resists for surface micromachining,” J. Micromech. Microeng., Vol. 10, pp. 108-15 (2000). A photoresist layer of the invention is generally deposited to be uniformly distributed across the surface of a substrate. SU-8 and related SU-8 resins may also be modified by additives in order to improve properties of the resin such as flexibility.

Deposition of an exemplary photoresist onto the device substrate and layer formation involves spin-on deposition of the photoresist, a soft bake, exposure to UV or near UV light, a post-exposure baking, selective removal of the unexposed portions of the layer, rinsing of the unexposed portions from the substrate and hard baking the exposed portions of the layer as a final cure. One embodiment of the invention deposits a single layer onto the substrate surface of a microfluidic device. The surface of the substrate is cleaned and polished to provide an even and uniform deposition surface. The layer is deposited on the substrate by a suitable deposition technique including, but not limited to, spin-on deposition, screen printing, tape casting, cold pressing, ink jet printing, hot embossing or chemical vapor deposition. An adhesion promoter can also be distributed onto the surface of the substrate prior to deposition to enhance adherence of the layer thereto.

After layer deposition, the layer can optionally be baked, for example, on a hot plate or in a convection oven so as to remove plasticizers, dispersants, binders, solvents or other materials present within the layer. A hot plate is generally preferable for baking as it allows such materials to be driven from the bottom to the top of the layer and minimizes the formation of off-gassing bubbles. Baking of the layer promotes layer uniformity and adhesion to the substrate surface. The layer is then exposed to a UV or near UV light source. An example of one such source is a mercury arc source or discharge lamp. The exposure to UV or near UV light can be through an opening in a photomask so as to harden topological features in the layer. An exemplary photomask is comprised of chrome on fused silica or glass. The hardened topological features correspond to the exposed portions of the layer. The topological features are thereafter formed as any unexposed portions are removed or dissolved from the layer such as by mechanical or chemical techniques.

After exposure to UV or near UV light, the layer can optionally be subjected to a post-exposure bake that sufficiently cross-links the layer. This post-exposure bake may occur on a hot plate or in a convection oven, for example, and preferably before removal of the unexposed portions of the layer. Any unexposed portions of the deposited layer can, for example, be developed or removed by a solvent such as cyclopentanone, GBL, diacetone alcohol, methyl isobutyl ketone, ethyl lactate or PGME. The solvent can then be rinsed from the substrate along with any unexposed layer portions. As described, the remaining exposed and hardened portions of the layer define topological features for the microfluidic device. The layer could also be subjected to a final cure in, without limitation, a convection oven so as to improve various physical, mechanical, thermal and chemical properties of the layer.

A layer deposited on a microfluidic device according to the invention could also be formed into a plurality of topological features by methods that do not involve or require a photomask. The methods include conventional pattern transfer techniques such as soft lithography, which employs a micropatterned mold. The inverse of a mold pattern is transferred to the layer to form topological features along its surface. Common soft lithography techniques include, without limitation, microtransfer molding, micromolding in capillaries, and replica molding. Such techniques could be used after deposition of the layer onto the surface of the substrate and before exposure of the layer to UV or near UV light.

A variety of topological features can be formed along a layer deposited onto the surface of a substrate for a device according to the invention. A patterned array of wells and channels have previously been mentioned, although these features do not limit the many different types of features that are contemplated by the invention. Such different types of features include, but are not limited to, loading ports, flow control channels, mixing and reactions zones, nutrient channels, recovery wells or any combination thereof. These features can be used in a device of the invention fabricated to be a fiber optic interrogated microarray or microtiter plate. It is also contemplated that a 5 μm feature resolution is achievable for a microfluidic device of the invention. Process characteristics for improving the chemical, thermal and physical properties of SU-8 or SU-8 related resin layers are generally described by Johnson et al., “Improving the process capability of SU-8, part II, pp. 1-7, www.microchem.com/resources/su8_process_capability_paper_{—}2.pdf.

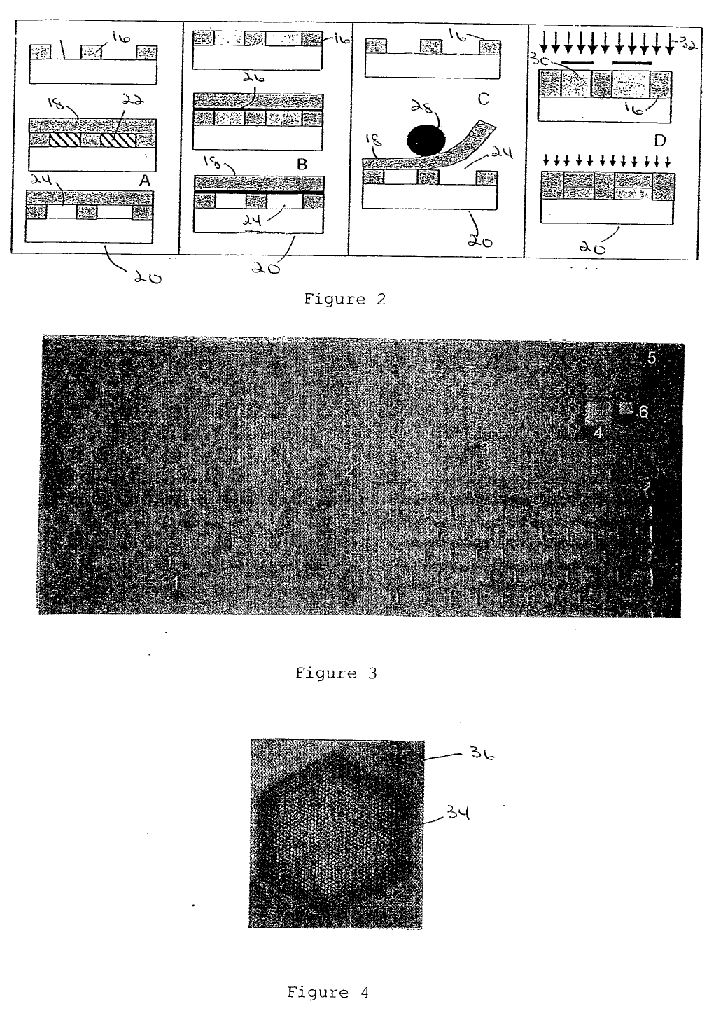

In an alternative embodiment, a second layer is deposited onto the original layer of the microfluidic device substrate. FIG. 2 shows four different schemes for a layer 16 receiving a second deposited layer 18. The second layer 18 can be deposited onto the first layer 16 of a microfluidic device 20 to form a network suitable for flow of a fluid such as a sample fluid. With the first scheme, a filling material 22 is used to form channels 24 integral with the first layer 16 and second layer 18. The channels 24 for any of the schemes in FIG. 2 are suitable for flow of a fluid sample such as, for instance, a molecular, a cellular, a proteomic or a genomic material or assay. An event, such as, without limitaton, a biological, chemical or physical event, associated with the material or assay can also be interrogated. The fluid sample can be interrogated by at least one optic fiber of the device 20.

The second scheme shows a mask 26 that protects the first layer 16 so as to allow channels 24 to form between the first layer and the second layer 18. The third scheme shows a second layer 18 being laminated onto the first layer 16 in order to form channels 24. This lamination is aided by a weight 28 as shown in FIG. 2. The fourth scheme then shows unexposed portions 30 of the first layer 16 receiving a deposited second layer 18. This scheme also shows both layers being hardened by UV or near UV light 32 such that the unexposed portions 30 are covered from the light by the second layer 18. The unexposed portions 30 do not harden and can be removed to form channels similar to those of the other illustrated schemes. Any sort of suitable features in addition to channels can be fabricated integrally with a microfluidic device by deposition of a first layer and a second layer.

As described above, one or more portions of the layer could be cured or hardened such as by exposure to a light source through an opening in a photomask. A typical photomask is comprised of chrome on fused silica or glass. The exposed portions then form hardened topological features along the layer. The layer portions that are unexposed remain unhardened and these portions could be removed by any suitable mechanical or chemical process. A layer could also comprise a label or marking formed in or otherwise integral therewith for identification of a given microfluidic device. Substrates or optic fibers according to the invention can also comprise, but are not limited to, any of the arrangements, configurations, assemblies, materials or any other variations disclosed and described within U.S. Pat. Nos. 4,693,552, 4,669,813, 4,647,152, 4,591,232 and 4,533,210, which are incorporated by reference herein.

FIG. 3 is a magnified image of six microfluidic devices according to the invention in which an SU-8 2025 resin layer is formed on a substrate integrally comprising 3 μm diameter optic fibers that comprise core glass surrounded by fused clad glass. The microfluidic devices shown comprise six different patterned layers that define topographical features of various microsizes. The patterned layers specifically comprise a discrete array of microwells in which each layer is numbered 1 through 6. These devices could be used in microarray plate applications. Each of the array layers has different dimensions that are approximately identified within Table 1, which is not provided to in any way limit the scope of the disclosure or a particular embodiment of the invention.

TABLE I

| Patterned Array | Microwell | Microwell |
|---|---|---|
| Number | Diameter | Pitch |
| 1 | 300 μm | 400 μm |
| 2 | 150 μm | 200 μm |
| 3 | 120 μm | 160 μm |
| 4 | 30 μm | 40 μm |
| 5 | 60 μm | 80 μm |
| 6 | 15 μm | 20 μm |

The layer thickness or microwell depth for each patterned layer in FIG. 3 is approximately 56 μm to 57 μm. The feature resolution of an exemplary microwell could also be less than about 5 μm.

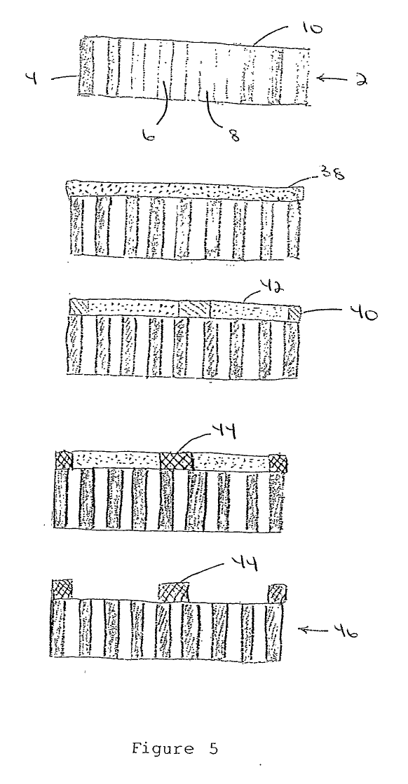

A plurality of optic fibers substantially define the bottom of each microwell shown in FIG. 3. FIG. 4 is a magnified image of one microwell from the third patterned layer illustrated in FIG. 3. As shown, optic fibers 34 along the bottom of the microwell 36 communicate with the microwell and are capable of interrogating a sample comprising a diverse group of materials or assays including those that are molecular, cellular, proteomic, genomic or gaseous in nature. The material or assay could be associated with a biological, chemical or physical event that can also be interrogated. The quantity of fibers 34 along the bottom of the microwell 36 tends to provide exceptional optical or image resolution while limiting the extent, for example, of noise or other interferences. The layer thickness of the microwell in FIG. 4 is approximately 56 μm to 57 μm.

FIG. 5 is a scheme for fabricating a microfluidic device of the invention. As shown, the substrate 2 integrally comprises optic fibers 4 that comprise a core glass region 6 surrounded by clad glass 8 that is fused together. One layer 38 is deposited onto the surface 10 of the substrate by a spin-on process. Portions 40 of the layer are exposed to UV or near UV light and harden as any unexposed portions 42 do not harden. UV or near UV light reaches the exposed portions 40 of the layer through openings in, for instance, a photomask disposed between the deposited layer 38 and a UV or near UV light source. Unexposed portions 42 of the deposited layer are removed by mechanical or chemical processing to form topological features 44 along the layer. The layer 38 can then be sufficiently cross-linked during a post-exposure bake to improve its properties. The final device 46 has a layer 38 integrally adhered to the substrate 2 and having topological features 44 for substantially containing a sample.

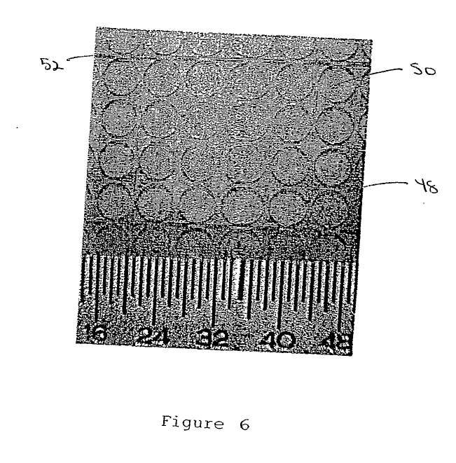

FIG. 6 shows through magnification an exemplary SU-8 layer formed on a substrate comprised of 6 μm diameter optic fibers. The device shown comprises a layer 48 that defines topographical features. The features comprise a patterned array of microwells 50 that may form a microtiter plate. The microwells 50 can individually contain a sample volume of fluid that is about 2 microliters (μl). A photomask(s) has been used to assist with fabrication of the microwells 50 into discrete 4 by 4 arrays that are demarcated by slots 52 that tend to reduce stress. The patterned arrays shown in FIG. 6 are subsets of a 1536 well microtiter plate.

The curing or hardening of any layer of the invention might be accomplished by processes that include photopolymerization, polymerization, thermal curing or photocuring. The topological features of such a layer can also comprise a patterned array of wells, channels or any combinations thereof. As the layer is hardened, it also adheres to the surface of the substrate. The layer adheres to the substrate optimally when the substrate surface has been evenly and uniformly polished. Any of the various topological features of the layer can differ in size from μm to mm as well as in volume. The thickness of a hardened layer adhered to the substrate also tends to vary depending on the intended use of the device. A device generally has a thickness of, for example, about 1 μm to 200 μm when used as a microarray plate.

A formed well communicates with at least one optic fiber of a substrate. In one embodiment, a particular well may communicate with a plurality of optic fibers that could number up to and include thousands. An embodiment of the invention having a plurality of optic fibers communicating with an individual well can be used as a microarray or microtiter plate. A microfluidic device may also include numerous wells communicating with different optic fibers that can simultaneously interrogate multiple samples. The optic fibers of the invention may be coupled to standard detection equipment including, for instance, at least one CCD. Standard detection equipment also comprises hardware and software appropriate for sample interrogation. The microfluidic device can also include several channels formed by a hardened layer that can separate portions of the device for interrogation or analysis of different samples such as a fluid sample.

As described previously in reference to FIG. 2, another embodiment of the invention comprises a second layer formed on the original layer of the device. The second layer is preferably a photoresist material such as a polymeric resin. The second layer is deposited on the substrate by a suitable deposition technique such as those described above. Soft lithography or a photomask could also be used to form topological features along the second layer as it is hardened by processes that include, for instance, photopolymerization or photocuring. The second layer may then yield a microfluidic device that operates as a network. The network can be used for fiber optic interrogation of a fluid sample such as, for example, a material or an assay.

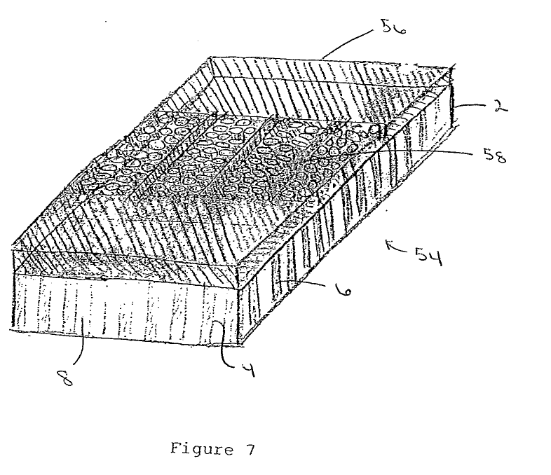

FIG. 7 is a partial representation of a device 54 of the invention comprising a layer 56 defining channeled features 58. As shown, the substrate 2 integrally comprises optic fibers 4 that comprise core glass 6 surrounded by clad glass 8. A layer 56 may be deposited onto the surface of the substrate by a spin-on process. Portions of the layer 56 are then exposed to UV or near UV light and harden, while other unexposed portions of the layer do not harden. UV or near UV light reaches the exposed portions of the layer 56 through openings in, for example, a photomask disposed between the deposited layer and the UV or near UV light source. Unexposed portions of the deposited layer are removed by mechanical or chemical processing to form topological features along the layer that are channels 58.

The layer 56 and its patterned array of channels 58 may then be sufficiently cross-linked to improve properties thereof. The final device 54 is a layer 56 being integrally adhered to the substrate 2 and having topological features that could substantially contain at least one sample flow for interrogation. For example, reagents might flow across the substrate and its integral layer. Such reagents may include, without limitation, molecular, cellular, proteomic or genomic materials or assays. The channels 58 of the device 54 shown within FIG. 7 could also act, for example, as flow control channels, mixing and reactions zones, nutrient channels, loading ports or any sort of combination thereof. Each of the topological features of the formed layer can also be used to contain a biological, chemical or physical event that may be optically interrogated according to the invention.

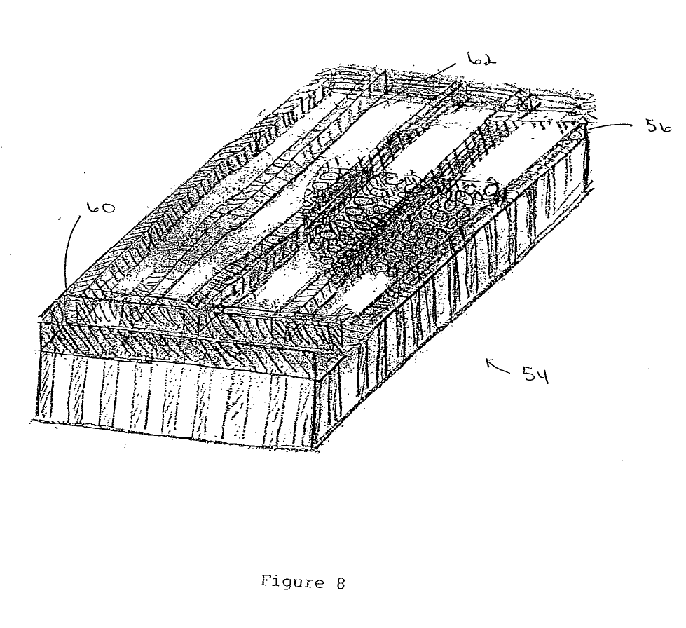

A network could also be comprised from the device shown in FIG. 7 by depositing layers onto the original layer of the device. Such a network might be used to investigate a sample flow such as a reagent flow. FIG. 8 is a partial representation of the device 54 of FIG. 7 comprising a second layer 60 having channeled features 62 and being disposed onto the first layer 56. It may not be necessary for the second layer 60 to have any substantially formed topological features as the layer 60 could generally be a flat layer integral with the first layer 56. Such flat layers are shown within the schemes of FIG. 2 described above. The network in FIG. 8 may also be suitable for sample interrogations as well as a variety of applications including, for instance, loading ports, nutrient channels, flow control channels, mixing and reactions zones or any combination thereof.

The invention also provides a method for fabricating a microfluidic device. The method includes providing a substrate integrally comprising a plurality of optic fibers. A surface of the substrate is polished and cleaned to provide for even and uniform distribution of a layer(s). Notwithstanding polishing, a substrate surface can, for instance, have a measurable surface morphology with peak to valley differences of about 0.005 μm. The layer can be deposited on the polished substrate surface by such deposition techniques as spin-on deposition, screen printing, tape casting, cold pressing, ink jet printing, hot embossing or chemical vapor deposition. A portion or several portions of the layer may then be cured or hardened to form topological features that communicate with at least one optic fiber for interrogation of a sample.

The microfluidic device fabricated according to the method of the invention preferably comprises a plurality of topological features that comprise a patterned array of, for example, wells, channels or a combination thereof. Moreover, other features that are contemplated include, without limitation, loading ports, flow control channels, mixing and reactions zones, nutrient channels, recovery wells or any combination thereof. The present invention further provides a method for interrogating multiple samples in parallel via the microfluidic devices fabricated according to the invention. Such interrogations may include any of those that are described above or other interrogations, analyses or diagnostics that could be contemplated.

The embodiments described above can be used as either a microarray or microtiter plate. A microfluidic device according to the invention could further be used for an application that typically would involve a biosensor or biochip employing special loading features and amplification chambers. In one embodiment, a microfluidic device could be used to detect small changes in a specific deoxyribonucleic acid (DNA) sequence. The microfluidic device could further be used to detect a single nucleotide polymorphism (SNP), which might indicate a predisposition to a disease. A microfluidic device of the invention may also be used as a platform or structure for polymerase chain reaction (PCR) amplification.

In another embodiment, the device could also be used in conjunction with array technology to enable both cost effective and high-throughput genotyping. Similar array type technology used in conjunction with a microfluidic device of the invention may be effective for recombinant nucleic acid (RNA) profiling. Bacteria, viruses, cells and so forth can also be grown and monitored by a disclosed microfluidic device. A microfluidic device of the invention could further be fabricated such that conventional automated equipment may deposit samples onto or withdraw samples from the device. A microfluidic device that acts as a 96, 192, 384 or 1536 well microtiter plate may be an example of a device that can be used with such equipment.

One embodiment of the invention may also comprise wells disposed within at least one topological feature of a device layer. Such a microfluidic device could be fabricated using a chemical etchant like mineral acid to selectively dissolve the soluble core glass of optic fibers comprising the device substrate without perturbing the more resistant clad glass of the substrate. The core glass is dissolved and then rinsed away to yield wells that are physically defined by the intact clad glass. A plurality of etched wells can be disposed within at least one topological feature of a device layer. An example of such a microfluidic device may comprise optic fiber etched wells disposed within each of the wells of a layer. The optic fiber etched wells would necessarily have a smaller diameter than that of the wells along the microfluidic device layer.

The method for fabricating a device of the invention is convenient and could be accomplished using standard techniques and equipment. The method also does not limit or restrict topological features to communicate or correspond with one optic fiber, although such devices could also be fabricated. The method of the invention is useful for fabricating microfluidic devices that operate as either a microarray or microtiter plate. The method may further not produce an excess of residual or glass byproducts that could pose environmental issues. The method and device described herein each allow for a standardized substrate onto which a layer of the invention might be deposited. Such standardization could reduce overall inventory costs for research and related facilities.

The method and device of the invention can also be used to conveniently investigate up to, without limitation, thousands of material or assay samples in parallel. These material or assay samples could include, for instance, various molecular, cellular, proteomic, genomic or gaseous materials or assays. A microfluidic device according to the invention can also be used to interrogate sample reagents flowed across the substrate and its integral layer. A network comprised of a device having multiple layers can also be used to investigate a sample flow such as a material or an assay. The embodiments according to the invention tend to enhance optical interrogation resolution when compared to other optical-based processes or techniques.

The fabrication method of the invention can also be used to easily customize a microfluidic device for a particular area of research. As mentioned, the optical sensitivity and resolution of a device of the invention tends to exceed that of conventional interrogation techniques, which can include bulky add-on equipment or tools that interfere with or disrupt a sample or an associated event that is being interrogated. A microfluidic device of the invention can further include a label that is integral with a deposited and adhered layer. Such a label may be used to identify and catalog a particular microfluidic device.

The examples herein are provided to illustrate advantages of the present invention that have not been previously described and to further assist a person of ordinary skill within the art with fabrication of a microfluidic device according to the invention. The examples can include or incorporate any of the variations or embodiments of the invention described above. Moreover, the embodiments described above may each include or incorporate the variations of any or all other embodiments of the invention. The examples that follow are not intended in any way to otherwise limit the scope of the disclosure.

### EXAMPLE I

The present example involves a photoresist layer that is deposited onto a substrate of a microfluidic device according to the invention. The photoresist is the polymeric resin SU-8. An SU-8 layer is processed by UV or near UV light that can be in a wavelength range of approximately 350 nm to 450 nm. The exposure of SU-8 to UV or near UV light and post-exposure baking sufficiently cross-links the layer on the substrate surface. An SU-8 layer may partially cross-link as the photoresist forms a strong acid when exposed to UV or near UV light. Deposition of the SU-8 layer on the microfluidic device substrate and layer formation involves spin-on deposition of the photoresist, a soft bake, exposure to UV or near UV light, a post-exposure baking, selective removal of the unexposed portions of the layer, rinsing of the unexposed portions from the substrate and hard baking the exposed portions of the layer as a final cure.

The substrate on which the SU-8 photoresist layer will be deposited is cleaned and polished to provide an even and uniform deposition surface. The substrate also integrally comprises a plurality of optic fibers comprising a central core glass region surrounded by clad glass that is fused together. The surface of the substrate is cleaned by solvent or dilute acid followed by a deionized water rinse. The substrate could also be optionally etched prior to deposition of the photoresist. The substrate can also be dehydrated by baking at 250° C. for about 5 minutes on a contact hot plate or for about 30 minutes in a convection oven. The deposition and curing of the SU-8 photoresist layer is further described by www.microchem.com/products/pdf/SU8_{—}2002-2025.pdf.

The substrate may be fabricated to be an approximately 4 to 6 inch diameter wafer. For a given substrate comprised of optic fibers and clad glass, the wafer can be cut from a large block of optic fibers and clad glass. The wafer is also preferably cut to have a thickness of about 1 mm. The integrity and uniformity of the substrate can also be inspected. These inspections tend to address issues such as, for instance, blemishes, fractures, abrasions, beveling or cracking that could possibly result from the routine manufacture of the substrate. The substrate may then be cleaned by using laboratory detergent, deionized water and isopropanol alcohol and polished to provide an even and uniform deposition surface. Prior to any deposition of the photoresist, the substrate is generally baked on a hot plate at 250° C. for no less than about 10 minutes.

SU-8 is deposited on the substrate surface at an aliquot volume of approximately 1 milliliter (ml) per inch of substrate diameter. The cycle for spin-on deposition includes an initial spin speed to spread the SU-8 aliquot and a final spin speed that tends to determine the thickness of the layer. The spread portion of the cycle can involve ramping the substrate to 500 rpm at a 100 rpm per second rate of acceleration. A spread portion of the cycle is then followed by ramping to a final spin speed of about 1,000 rpm to 3,000 rpm at a rate of acceleration of about 300 rpm per second. The final spin speed is then held for a total of approximately 30 seconds. After the photoresist is deposited onto the substrate, it is soft baked to evaporate any solvent and densify the layer. The soft bake of SU-8 can be performed by a hot plate or a convection oven. The soft bake of the photoresist is preferably ramped or stepped to uniformly evaporate any solvent from the layer. A uniform and controlled solvent evaporation tends to improve the consistency of the photoresist and improve adhesion of the layer to the substrate.

The SU-8 photoresist is then exposed to UV or near UV light in a wavelength range of approximately 350 nm to 450 nm. One type or example of a UV or near UV light source may be a mercury arc source or discharge lamp. Such exposure according to the invention may also be from, for example, e-beam, i-line or x-ray sources. In order to form a plurality of topological features in the layer, a photomask can be used such that UV or near UV light passes through an opening in the photomask to harden the photoresist material. After UV or near UV light exposure, the layer is subjected to a post-exposure bake. As noted, the post-exposure bake sufficiently cross-links any of the portions of the layer that have been previously exposed to UV or near UV light. The post-exposure bake can be performed on a hot plate or within a convection oven. The post-exposure bake is preferably ramped or stepped in order to minimize layer stress.

The unexposed portions of the SU-8 layer are developed or dissolved by a solvent such as ethyl lactate, diacetone alcohol or any other solvent identified above. Dissolution of unexposed portions of the layer is preferably performed under agitation. The length of time in which the solvent is used for removing the unexposed portions of a layer can be from about 1 minute to 10 minutes. The period of any dissolution can also be reduced by employing different rates of agitation or temperatures. The unexposed portions of the layer are subsequently rinsed from the substrate surface followed by the substrate and layer being dried by an inert gas stream. A final cure of the exposed portions of the layer occurs on a hot plate or in a convection oven. The final cure might be a hard bake between temperatures of about 150° C. to 200° C. and can be preferably ramped or stepped to improve the overall properties of the layer. Such properties include, without limitation, the adhesion of the layer to a microfluidic device according to the invention.

### EXAMPLE II

The present example involves a given substrate integrally comprising optic fibers surrounded by clad glass. A photomask is used for hardening an SU-8 2100 resin layer deposited onto the surface of the substrate. An exemplary chrome on glass comprised photomask was obtained from Advanced Reproductions of North Andover, Massachusetts. The photomask was used to assist with the fabrication of 1,536 microwells uniformly patterned in a 32 by 48 microwell array. The substrate was prepared for layer deposition using laboratory detergent, deionized water and isopropanol alcohol. Prior to layer deposition, the substrate was baked on a hot plate at 250° C. for no less than approximately 10 minutes. It could also be preferable to heat the substrate to higher temperatures such as 400° C. for about 10 minutes before layer deposition to achieve negligible water contact angles.

The SU-8 2100 resin layer was applied as two layers so as to achieve a minimum target thickness of about 636 μm. The first layer was baked on a hot plate for about 5 minutes at about 65° C. followed by 30 minutes of heating at about 95° C. After the second layer was deposited, the layers were baked on a hot plate for approximately 5 minutes at about 65° C. followed by 60 minutes of heating at about 95° C. The thickness of the SU-8 2100 layer might also be measured after baking using a light sectioning microscope or a micrometer. A filtered UV or near UV light source was then used to hardened any exposed portions of the deposited layer having an intensity that was measured and determined to be about 10 milliwatts (mW) per cm².

The device was then submersed into a solution comprising a developer agent. The solution was contained within a covered beaker and agitated by a standard agitation platform. Agitation speed and duration were also monitored and controlled. The developer agent of the solution substantially dissolved any of the deposited layer that was previously unexposed to UV or near UV light. The sample was then rinsed with a fresh solution containing the developer agent and then rinsed with isopropanol alcohol and thereafter dried. The photomask that was used in this example was intended to assist with topological feature formation.

Similar and related parameters described by this example were further used for fabricating microfluidic devices according to the invention. Parameters that could be used for fabricating such devices are provided by example in Table II, which is not provided in any way to otherwise limit the scope of the disclosure or any particular embodiment of the invention. Table II also indicates the deposition rate (rpm) and thickness (μm) of a first resin layer and the deposition rate and overall thickness of a second resin layer. Table II shows the use of a silicon substrate material as a reference standard from which fabrication parameters such as layer thickness or exposure intensity can be established.

TABLE II

| | First | Second | Exposure | Exposure | Develop |
|---|---|---|---|---|---|
| Substrate | Layer | Layer | Time | Intensity | Time |
| Material | Deposition | Deposition | (seconds) | (mJ) | (minutes) |
| Silicon | 1500 rpm | 1500 rpm | 180 | 1200 | 22 |
| Wafer | 284 μm | 551 μm | | | |
| Core-Clad | 1500 rpm | 1250 rpm | 180 | 1800 | — |
| Glass | 284 μm | 625 μm | | | |
| Core-Clad | 1500 rpm | 1250 rpm | 180 | 1800 | — |
| Glass | 244 μm | 607 μm | | | |
| Core-Clad | 1250 rpm | 1250 rpm | 180 | 1800 | >30 |
| Glass | 300 μm | 592 μm | | | |
| Core-Clad | 1250 rpm | 1250 rpm | 180 | 1800 | >30 |
| Glass | 287 μm | 601 μm | | | |

Table II also shows substrates that integrally comprise optic fibers having a core glass surrounded by clad glass indicated as a core-clad glass substrate material. The overall layer may then be exposed to UV or near UV light, measured in millijoules (mJ), according to the parameters of time and intensity.

While the present invention has been described herein in conjunction with a preferred embodiment, a person of ordinary skill in the art, after reading the foregoing specification, will be able to effect various changes, substitutions of equivalents and other alterations to the devices and methods that are set forth herein. For instance, a substrate for a microfluidic device may also comprise an overlay or a laminate that is adhered to the substrate or the layer deposited thereon. The overlay or laminate could be adhered to a microfluidic device of the invention by any conventional techniques used during or after fabrication of the device. Each embodiment described above can also have included or incorporated therewith such variations as disclosed with regard to any or all of the other embodiments. It is therefore intended that protection granted by Letter Patent hereon be limited in breadth only by the definitions contained in the appended claims and any equivalents thereof.

What is claimed is:

1. A microfluidic device for fiber optic interrogation of multiple samples, the microfluidic device comprising:
a substrate having a surface, the substrate integrally comprising a plurality of optic fibers; and
a layer formed on the surface of the substrate, the layer defining at least one topological feature, wherein the topological feature communicates with at least one optic fiber for interrogation of a sample.

2. The microfluidic device of claim 1, wherein the substrate is further integrally comprising clad glass.

3. The microfluidic device of claim 1, wherein at least one optic fiber comprises a region of core glass.

4. The microfluidic device of claim 1, wherein the topological feature of the microfluidic device comprises a well.

5. The microfluidic device of claim 1, wherein the topological feature of the microfluidic device comprises a channel.

6. The microfluidic device of claim 4 or 5, wherein the microfluidic device comprises a plurality of topological features, the plurality of topological features comprising wells, channels or a combination thereof.

7. The microfluidic device of claim 6, wherein the plurality of topological features comprises a patterned array.

8. The microfluidic device of claim 1, wherein the layer formed on the surface of the substrate comprises a photoresist material.

9. The microfluidic device of claim 8, wherein the photoresist material comprises a polymeric resin.

10. The microfluidic device of claim 9, wherein the polymeric resin is cross-linked.

11. The microfluidic device of claim 1, wherein the layer formed on the surface of the substrate has a thickness less than about 1000 mm.

12. The microfluidic device of claim 1, wherein the layer formed on the surface of the substrate has a thickness less than about 250 μm.

13. The microfluidic device of claim 6, wherein a diameter of at least one well is less than about 10 mm.

14. The microfluidic device of claim 1, wherein at least one optic fiber is associated with at least one charged coupled device for interrogation of the sample.

15. The microfluidic device of claim 1, wherein the sample is associated with a biological, a chemical or a physical event.

16. The microfluidic device of claim 1, wherein the microfluidic device further comprises a second layer formed on the layer.

17. The microfluidic device of claim 16, wherein the second layer defines at least one topological feature.

18. The microfluidic device of claim 16, wherein the second layer forms a network operable for the interrogation of a sample fluid.

19. The microfluidic device of claim 1, wherein the layer comprises a label, the label integral with the layer for identification of the microfluidic device.

20. A method of fabricating a microfluidic device for fiber optic interrogation of multiple samples, the method comprising:
providing a substrate having a surface, the substrate integrally comprising a plurality of optic fibers; and
depositing a layer on the surface of the substrate, the layer defining at least one topological feature, wherein the topological feature communicates with at least one optic fiber for interrogation of a sample.

21. The method of claim 20, wherein the method further comprises selectively curing a portion of the layer.

22. The method of claim 21, wherein the portion of the layer is selectively cured by exposure to light through an opening in a photomask.

23. The method of claim 21, wherein the method further comprises removing an uncured portion of the layer.

24. The method of claim 22, wherein the uncured portion of the layer is removed by a solution comprising a solvent.

25. The method of claim 20, wherein the layer is deposited on the surface of the substrate by a spin-on process.

26. The method of claim 20, wherein the method further comprises depositing a second layer on the layer.

27. The method of claim 26, wherein the second layer defines at least one topological feature.

28. The method of claim 26, wherein the second layer forms a network operably for interrogation of a sample fluid.

29. A method for fiber optic interrogation of multiple samples in parallel, the method comprising:
providing the microfluidic device of claim 1; and
contacting the layer with a sample, wherein the sample is partially contained by at least one topological feature.

30. The method of claim 29, wherein the method further comprises interrogating the sample or an event associated therewith, and further wherein interrogation is performed by at least one optic fiber.

31. The method of claim 29, wherein the layer is contacted by a plurality of samples, wherein each sample is partially contained by at least one topological feature.

32. The method of claim 31, wherein the method further comprises simultaneously interrogating the plurality of samples or an event associated with each sample, and further wherein simultaneous interrogation is performed by at least two optic fibers.

33. The method of claim 30 or 32, wherein at least one event is a biological, a chemical or a physical event.

34. The method of claim 30 or 32, wherein at least one optic fiber is operably associated with at least one charged coupled device.

35. The method of claim 34, wherein the charged coupled device receives a data from at least one optic fiber.

36. The method of claim 35, wherein the data received from at least one optic fiber is associated with at least one sample or event.

37. A microfluidic device for interrogation or analysis of multiple samples, the microfluidic device comprising:
a substrate having a surface, the substrate integrally comprising a plurality of diagnostic elements; and
a layer formed on the surface of the substrate, the layer defining at least one topological feature, wherein the topological feature communicates with at least one diagnostic element for interrogation or analysis of a sample.

38. The microfluidic device of claim 37, wherein the topological feature for the microfluidic device comprises a well.

39. The microfluidic device of claim 37, wherein the topological feature for the microfluidic device comprises a channel.

40. The microfluidic device of claim 38 or 39, wherein the microfluidic device comprises a plurality of topological features, the plurality of topological features comprising wells, channels or a combination thereof.

41. The microfluidic device of claim 40, wherein the plurality of topological features comprises a patterned array.

42. The microfluidic device of claim 37, wherein the layer formed on the surface of the substrate comprises a photoresist material.
